(19) United States
(12) Patent Application Publication
(10) Pub. No.: US 2015/0101439 A1
(43) Pub. Date: Apr. 16, 2015

(54) APPARATUS FOR OPERATING A SHIFT LEVER FOR A VEHICLE

(71) Applicants: Kia Motors Corp., Seoul (KR); Hyundai Motor Company, Seoul (KR)

(72) Inventors: Chang Hyun LEE, Seoul (KR); Han Gil Park, Suwon-si (KR); Yang Rae Cho, Suwon-si (KR)

(73) Assignees: Kia Motors Corp., Seoul (KR); Hyundai Motor Company, Seoul (KR)

(21) Appl. No.: 14/098,056

(22) Filed: Dec. 5, 2013

(30) Foreign Application Priority Data
Oct. 10, 2013 (KR) 10-2013-0120899

(51) Int. Cl. F16H 59/10

(52) U.S. Cl. CPC F16H 59/105
USPC 74/473.33

(57) ABSTRACT

An apparatus for operating a shift lever for a vehicle includes: a shift lever pattern part that includes a plurality of reference ranges in which a position of the shift lever is fixed, a parking range, and a shift lever moving path along which the reference ranges and the parking range are connected to one another; and a driving part that applies returning force to the shift lever so as to return the shift lever to the reference ranges if the shift lever deviates from the reference ranges and is located in the shift lever moving path.

### CROSS REFERENCE TO RELATED APPLICATION

The present application claims priority of Korean Patent Application Number 10-2013-0120899 filed Oct. 10, 2013, the entire contents of which application is incorporated herein for all purposes by this reference.

### BACKGROUND OF INVENTION

1. Field of Invention

The present invention relates to an apparatus for operating a shift lever for a vehicle that improves accuracy in shifting by way of realizing the same operation pattern of the automatic transmission as conventional patterns and reducing the distance by which the shift lever moves.

2. Description of Related Art

Basically, the speed change of a vehicle is carried out by a transmission that delivers the driving force from an engine to wheels, and a shift lever that selects the mode of the transmission.

Shift levers usually move in various shifting patterns, and a driver operates a shift lever in a shifting pattern so as to perform shifting.

Shifting patterns are provided not only to manual transmissions but also to automatic transmission. Different manufactures of shift levers and transmission have their own shifting patterns.

Typically, shifting patterns for automatic transmission are arranged in the order of “P-R-N-D,” and in some cases additional speed modes may be provided in the order of “3-2-1” following the D-range.

Recently, shift-by-wire (SBW) levers with unique patterns different from those of existing mechanical shift lever have been more commonly used. Since the shift levers are electronically operated, they have different patterns such as that the P-range and the N-range are co-located.

However, the shifting patterns of the SBW levers have problems in that driver may be unfamiliar or uncomfortable with the shifting patterns quite different from those of existing mechanical shift levers. In order to solve the problems, the shifting patterns emulating those of a mechanical shift lever may be conceivable. In this case, however, the distance between the positions is so close due to limitation of space that misoperation happens such as shifting from the P-mode to the R-mode is mistakenly made to the N-mode.

The matters described as the related art have been provided only for facilitating the understanding of the background of the present invention and should not be construed as acknowledging them as the prior art already known to those skilled in the art.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Various aspects of the present invention provide for an apparatus for operating a shift lever for a vehicle that has a shifting pattern emulating the shifting patterns of existing mechanical shift levers and also widens the distance between the shift modes.

Various aspects of the present invention provide for an apparatus for operating a shift lever for a vehicle, the apparatus including: a shift lever pattern part that includes a plurality of reference ranges in which a position of the shift lever is fixed, a parking range, and a shift lever moving path along which the reference ranges and the parking range are connected to one another; and a driving part that applies returning force to the shift lever so as to return the shift lever to the reference ranges if the shift lever deviates from the reference ranges and is located in the shift lever moving path.

The apparatus may further include: a parking switch operated by a driver; and a control unit that controls the driving part so that the shift lever is forced to move to the parking range by the operation of the driving part when the parking switch is pressed.

The plurality of reference ranges may include a first reference range and a second reference range connected to the first reference range.

A forward direction path that is connected to the first reference range and allows the shift lever to move by one section in the forward direction may be formed, and a reverse direction path that is connected to the second reference range and allows the shift lever to move by one section in the reverse direction may be formed.

If the shift lever moves in the forward direction path, the shift lever may be returned to the first reference range by the driving unit, and if the shift lever moves in the reverse direction path, the shift lever may be returned to the second reference range by the driving unit.

The forward direction path may be extended by one more section in the forward direction, and the parking range may be formed in the extended section.

The forward direction path may be bent so that the parking range is located on the left or right side of the forward direction path.

In addition to the reverse direction path, for entering a manual mode, a manual range M may be further provided that is connected to the second reference range to allow the shift lever to move in the later direction.

When the shift lever is located in any of the first reference range, the second reference range, and the manual range, the shift lever may be moved to the parking range by the driving part upon the parking switch being pressed.

The present methods and apparatuses have other features and advantages apparent from the accompanying drawings, incorporated herein, and below Detailed Description, which together serve to explain certain principles of the present invention.

### BRIEF DESCRIPTION OF THE DRAWINGS

FIG. 1 is a view illustrating an exemplary apparatus for operating a shift lever for a vehicle according to the present invention; and

FIG. 2 is a view illustrating a shifting pattern of an exemplary apparatus for operating a shift lever for a vehicle according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

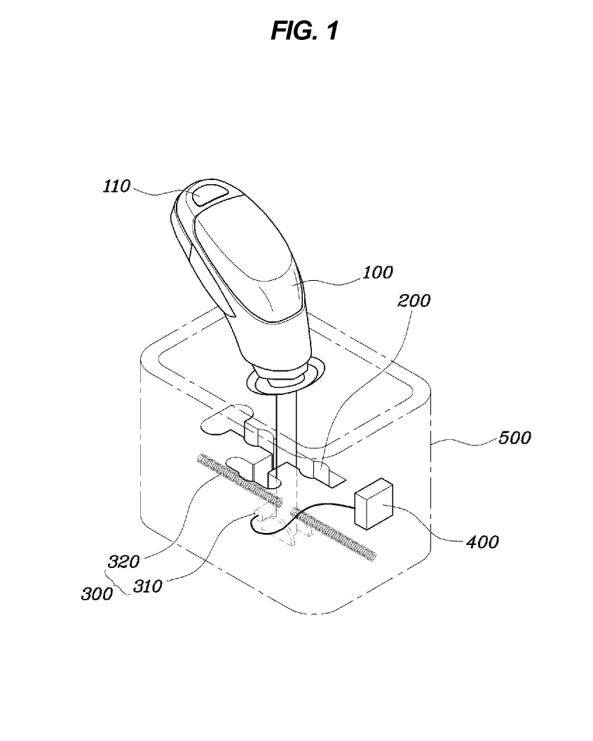

FIG. 1 is a view illustrating an apparatus for operating a shift lever for a vehicle according to various embodiments of the present invention, in which the shifting apparatus includes: a shift lever pattern part 200 that includes a plurality of reference ranges A in which a position of a shift lever 100 are fixed, a parking range P, and a shift lever moving path along which the reference ranges A and the parking range P are connected to one another are provided; and a driving part 300 that applies returning force to the shift lever 100 so that the shift lever 100 returns back to the reference ranges A if the shift lever 100 deviates from the reference ranges A and is located in the shift lever moving path.

Additionally, a parking switch 110 operated by a driver, and a control unit 400 that controls the driving part 300 so that the shift lever 100 is forced to move to the parking range P by the operation of the driving part 300 upon the parking switch 110 being operated, may further be included.

The parking switch 110 of the shift lever may be installed anywhere on the shift lever 100. If the parking switch 110 is operated, the shift lever 100 is always forced to move to the given parking range P by the driving part 300 no matter where it is.

The driving part 300 may be a motor 310. However, it is also possible to return the shift lever 100 to a given position by a hydraulic system by forming a fluid channel below the shift lever 100.

In addition, the driving part 300 may include elastic parts 320. The elastic parts 320 may be installed each on either side of the shift lever pattern part 200 in the longitudinal direction so as to be fixed to connect a shift lever housing 500 and the shift lever 100, so that the shift lever 100 may be always located at the reference ranges.

The control unit 400 may receive current shift mode information from a transmission control part in a vehicle and transmits the shift mode information to the transmission control part when the shift lever 100 is moved so as to perform shifting, so that shifting of the shift mode is appropriately performed according to the movement of the shift lever 100. The transmission control part may be a transmission control unit (TCU).

Although the control unit 400 may determine the range at which the shift lever 100 is currently located by detecting the movement of the driving part 300, a position sensor that is connected to the shift lever 100 and detects a range the shift lever 100 is currently located may be further included, so that the position information of the shift lever 100 may be sent to the control unit 400.

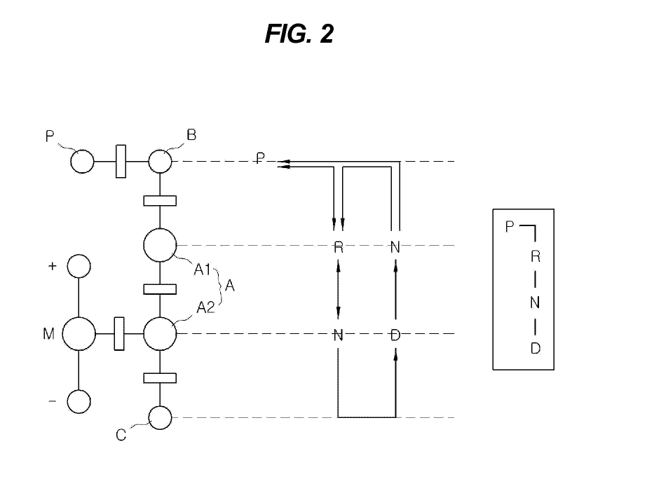

Now, the shifting apparatus according to various embodiments of the present invention will be described in more detail with reference to FIG. 2.

FIG. 2 is a view illustrating a shifting pattern of an apparatus for operating a shift lever for a vehicle according to various embodiments of the present invention in which the plurality of reference ranges may include a first reference range A1 and a second reference range A2 connected to the first reference range A1. The shift lever may be moved from the second reference range A2 to the first reference range A1 by one operation.

Further, a forward direction path by which the shift lever 100 may move by one section in a forward direction may be connected to the first reference range A1, and a reverse direction path by which the shift lever 100 may move by one section in a reverse direction may be connected to the second reference range A2.

Here, the forward direction refers to a direction from the second reference range A2 to the first reference range A1, and the reverse direction refers to a direction from the first reference range A1 to the second reference range A2.

That is, referring to FIG. 2, the forward direction refers to an upward direction from the first reference range A1 and the reverse direction refers to a downward direction from the second reference range A2.

The forward direction path may be extended by one more section in the forward direction, and the parking range may be formed in the extended section.

That is, the shift lever 100 may move the total two sections in the forward direction along the forward direction path, in which the second range is the parking range P. Accordingly, the shift lever 100 returns back to the reference ranges after it has moved by one section along the forward direction path, whereas the shift lever 100 does not return back to the reference ranges after it has moved by two sections along the forward direction path since it is located at the parking range P. Needless to say, the shift mode at this time is P-mode and thus the vehicle is parked.

By providing the additional parking range P, a driver may operate in the same manner of P-R-N-D as in the conventional vehicles. Further, since a driver may perform shifting to the P-mode by directly moving the shift lever to the parking range as well as operating the parking switch 110, the driver need not to adapt to a new shift pattern but may use the shift lever 100 in the familiar manner.

Additionally, the forward direction path may be bent so that the parking range P is located on the left or right side of the forward direction path. By locating the parking range P on the left or right side of the forward direction path, not on the same line with the forward direction path, if the shift lever is moved to the R-mode, it is possible to prevent the shift lever 100 from being mistakenly moved to the P-mode, instead of the R-mode.

Further, it is not necessary to set the first and second reference ranges A1 and A2 to perform the function of the parking range P, and thus a drive may operate shifting without confusion.

Further, since it is required to intentionally move the shift lever 100 to the left or right in order to perform shifting to the P-mode, a driver may ensure that her/his vehicle is correctly placed into the parking mode.

The shifting may be performed while moving the shift lever 100 in the forward direction path and the reverse direction path, for example, in the order of “P-R-N-D.” For example, the parking range P, the first reference range A1, the second reference range A2, and the first section in the reverse direction path may be matched to P, R, N, D, respectively.

However, each of the sections may not have the give shift mode only. This is because that when the shift lever 100 moves in the forward direction path, it may return to the first reference range A1 by the driving part 300, and when the shift lever 100 moves in the reverse direction path, it may return to the second reference range A2 by the driving part 300.

The shift lever 100 may return to the first reference range A1 or the second reference range A2 by the additionally installed elastic part 320 or by the motor 310.

More specifically, referring to FIG. 2 which illustrates a shifting pattern of a shifting apparatus for a vehicle according to various embodiments of the present invention, shifting is performed in the order of “P-R-N-D” as the shift lever 100 moves from the parking range P, the first reference range A1, the second reference range A2, and the first section in the reverse direction path. It is noted that the shift lever 100 is always returned to the first reference range A1 after it has moved by one section (hereinafter referred to as B) in the forward direction path and is always returned to the second reference range A2 after it has moved by one section (hereinafter referred to as C) in the reverse direction path. That is, if shifting from the N-mode to the D-mode is performed, the shift lever 100 is moved from the second reference range A2 to the C position and is immediately returned to the second reference range A2 by the driving part 300. It is noted that shifting to the D-mode is maintained and only the shift lever 100 moves.

If shifting from the R-mode to the N-mode is performed, the shift lever 100 is to be moved from the first reference range A1 to the second reference range A2. However, the shift lever 100 is already located at the second reference range A2 and stays at the second reference range A2 instead of returning back to the first reference range A1, without requiring the operation of the driving part 300.

For another example, let us consider a case that after shifting from the N-mode to the D-mode, the shift lever 100 is located at the second reference range A2 by the driving part 300, and then shifting to the N-mode is to be performed. In this case, in order to shift to the N-mode in the order of “P-R-N-D,” the shift lever 100 is to move by only one section, and thus the shift lever 100 may be moved from the second reference range A2 to the first reference range A1. In this case, the shift lever 100 stays at the first reference range A1 without being returned to the second reference range A2 from the first reference range A1.

Further, if shifting from the N-mode to the R-mode is performed, the shift lever 100 is moved to the B position in the forward direction path, and then the shift lever 100 is returned back to the first reference range A1 and the shifting to the R-mode is maintained.

In the case that the shift lever 100 is moved from the R-mode to the P-mode, if the shift lever 100 is located in the first reference range A1, the shift lever 100 is moved in the forward direction path beyond the B position to the parking range P, thereby perform shifting to the P-mode.

It is apparent that the same is applied to the case when the current shift mode is N and the shift lever 100 is located in the first reference range A1. In this case, if the shift lever 100 is located to the B position in the order of “P-R-N-D,” shifting to the R-mode is performed, and a driver moves the shift lever 100 to the parking range P without returning it back to the first reference range A1, so that shifting to the P-mode is performed.

In the case that the current shifting position is P, if the shift lever 100 is moved from the parking range P to the B position, it is returned back to the first reference range A1 by the driving part 300. Although the shift lever 100 has moved by two sections, actually a driver has moved the shift lever 100 from the parking range P to the B position and then driving part 300 has moved it thereafter, and thus only change from the P-mode to the R-mode has occurred, and, accordingly, the shift lever 100 is located in the first reference range A1 but the shift mode is R.

In addition to the reverse direction path, for entering a manual mode, a manual range M may be further included that is connected to the second reference range A2 to allow the shift lever 100 move in the lateral direction.

Here, the lateral direction is the third direction other than the forward and reverse directions and may be any direction except the forward and reverse directions. The lateral direction may be perpendicular to the forward and reverse directions for easy operation of the shift lever 100, as shown in FIG. 2.

The manual range M is to perform shifting manually. In order to allow the shift lever 100 to move by one section upwardly and downwardly in the manual range M, it is preferable that additional paths connected to the manual range M are provided.

When the shift lever 100 is located in any of the first reference range A1, the second reference range A2, and the manual range, if the parking switch 110 is pressed, the shift lever 100 may be moved to the parking range P by the driving part 300.

That is, no matter which current shift mode is, if the shift lever 100 is located in the second reference range A2, the shift lever 100 is moved to the parking range P by the driving part 300 when the parking switch 110 is pressed. Even if the shift lever 100 is located in the manual range M, the shift lever 100 is moved to the parking range P by the driving part 300 when the parking switch 110 is pressed.

Accordingly, no matter where the shift lever 100 is located, the shift lever 100 may be always moved to the parking range P when the parking switch 110 is pressed.

As described above, by setting five sections, it is possible to obtain sufficient distance between the sections in the limited space where the shift lever 100 may be operated, so that misoperation such as mistakenly moving the shift lever 100 by two sections in the reverse direction instead of one section, can be prevented. In particular, in the case of shift-by-wire (SBW) type, electronic shift lever 100, since the space is much smaller than that of existing mechanical shift lever, it is desirable that space occupied by the shift lever 100 and the distance by which the shift lever 100 moves are reduced. Therefore, the above-described description is more advantageous in electronic shift levers 100.

According to the shift lever 100 for a vehicle as described above, the shifting pattern may be set to be the same with that of existing mechanical shift levers, and thus it is possible to prevent drivers' confusion and to make the product more competitive.

In addition, by setting five sections in which the shift lever 100 may move, distance between the shift modes are extended within the same space, so that misoperation can be significantly reduced.

Moreover, shifting to the parking position can be performed not only by the parking switch but also by the shift lever 100, providing options in shifting to the P-mode.

As set forth above, according to the apparatus for operating a shift lever of the present invention, the shifting pattern may be set to be the same with the shifting patterns of existing mechanical shift levers, and thus it is possible to prevent drivers' confusion and to make the product more competitive.

In addition, by setting five or six sections in which the shift lever moves, distance between the shift modes may be extended within the same space, so that misoperation can be significantly reduced.

For convenience in explanation and accurate definition in the appended claims, the terms upper or lower, front or rear, inside or outside, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof It is intended that the scope of the invention be defined by the Claims appended hereto and their equivalents.

What is claimed is:

1. An apparatus for operating a shift lever for a vehicle, the apparatus comprising:
a shift lever pattern part that includes a plurality of reference ranges in which a position of the shift lever is fixed, a parking range, and a shift lever moving path along which the reference ranges and the parking range are connected to one another; and
a driving part that applies returning force to the shift lever so as to return the shift lever to the reference ranges if the shift lever deviates from the reference ranges and is located in the shift lever moving path.

2. The apparatus according to claim 1, further comprising:
a parking switch operated by a driver; and
a control unit that controls the driving part so that the shift lever is forced to move to the parking range by the operation of the driving part when the parking switch is pressed.

3. The apparatus according to claim 1, wherein the plurality of reference ranges includes a first reference range and a second reference range connected to the first reference range.

4. The apparatus according to claim 3, wherein a forward direction path that is connected to the first reference range and allows the shift lever to move by one section in the forward direction is formed, and a reverse direction path that is connected to the second reference range and allows the shift lever to move by one section in the reverse direction is formed.

5. The apparatus according to claim 4, wherein if the shift lever moves in the forward direction path, the shift lever is returned to the first reference range by the driving unit, and if the shift lever moves in the reverse direction path, the shift lever is returned to the second reference range by the driving unit.

6. The apparatus according to claim 4, wherein the forward direction path is extended by one more section in the forward direction, wherein a parking range is formed in the extended section.

7. The apparatus according to claim 6, wherein the forward direction path is bent so that the parking range is located on the left or right side of the forward direction path.

8. The apparatus according to claim 4, wherein a manual range for entering a manual mode is further provided, the manual range being connected to the second reference range in addition to the reverse direction path so as to allow the shift lever to move in a lateral direction by one section.

9. The apparatus according to claim 8, wherein, when the shift lever is located in any of the first reference range, the second reference range, and the manual range, the shift lever is moved to the parking range by the driving part upon the parking switch being pressed.
